(19) United States
(12) Patent Application Publication
(10) Pub. No.: US 2020/0160359 A1
(43) Pub. Date: May 21, 2020

(54) USER-EXPERIENCE DEVELOPMENT SYSTEM

(71) Applicant: Worcester Polytechnic Institute, Worcester, MA (US)

(72) Inventors: Ryan M. LaMarche, Holden, MA (US); Chris Chagnon, Worcester, MA (US); Soussan Djamasbi, Natick, MA (US)

(73) Assignee: Worcester Polytechnic Institute, Worcester, MA (US)

(21) Appl. No.: 16/690,657

(22) Filed: Nov. 21, 2019

Related U.S. Application Data
(60) Provisional application No. 62/770,380, filed on Nov. 21, 2018.

(51) Int. Cl. G06Q 30/02; G06Q 10/10

(52) U.S. Cl. CPC G06Q 30/0201; G06Q 10/101

(57) ABSTRACT

Embodiments of the innovation relate to a persona development device comprising a controller having a memory and a processor. The controller is configured to receive a research request from a user interaction device, the research request including an attribute related to a persona. The controller is configured to, in response to identifying a correspondence between the attribute of the research request and a persona of a persona database, forward a request response including the persona to the user interaction device. The controller is configured to, in response to identifying a lack of correspondence between the attribute of the research request and a persona of a persona database, retrieve user data from a user data source, create a persona prototype based upon the user data and corresponding to the attribute of the research request, and forward a request response including the persona prototype to the user interaction device.

### RELATED APPLICATIONS

This patent application claims the benefit of U.S. Provisional Application No. 62/770,380, filed on Nov. 21, 2018, entitled, “User-Experience Development System,” the contents and teachings of which are hereby incorporated by reference in their entirety.

### BACKGROUND

Successful competition in today's global and increasingly crowded markets requires companies to develop products and services with outstanding user-experiences. One way to achieve this goal is by developing representative customer personas to guide the design of services or products for targeted users. With persona development, a company can identify similar behavioral patterns, preferences, attitudes, needs, goals, and motivations of its customers and can create a representative customer persona based upon these criteria. The company can then utilize the customer persona to develop a product that will satisfy its user's needs.

For example, a business such as a car dealership may develop a customer persona for use in designing a particular user-experience, such as an online maintenance service scheduling experience for the dealership. During a customer persona development process, the business can initially select the experience it wants to design, such as an on-line car maintenance service-scheduling and reporting experience. Next, the business creates unstructured interview questions, recruits targeted customers, and interviews those customers. The business can then analyze the interviews, identify behavior patterns based upon the interviews, and group the patterns into one or more customer personas. As a result, the developed personas can provide the business with insight into various aspects of its customers when developing the online maintenance service scheduling application.

Generally, a customer persona can be created for any industry and for any purpose. In certain cases, a business can develop different types of personas for each of its different departments. For example, in addition to the customer persona developed for the service team in the car dealership, a marketing team may want to develop a customer persona to improve company's market reach via various media strategies while an engineering team may want to develop a competitive dashboard design for its newest models by better understanding customer preferences and needs.

Because customer personas describe a great deal about a group of users, including their needs and goals, they can be used to facilitate product design guidelines. For example, the customer personas can help prioritize which design goals are more important than others. The success of a design can be tested with user experience tests and/or via analytics such as number of visits, completed transactions, units sold, etc.

### SUMMARY

Personas are very versatile and can be used in different company operations, such as when developing new products for existing customers or exploring new markets for existing or new products. However, conventional persona development can suffer from a variety of deficiencies.

As provided above, companies typically develop customer personas manually via interviews or, in case of proto-personas, through workshops conducted with employees that know the customer. This customer persona development process, however, is relatively time intensive. Further, for relatively large organizations, persona development can be an inefficient process as different departments within the same company may need to develop similar types of personas. For example, in a car company, a marketing team may want to develop personas to improve company's market reach via various media strategies while the engineering team in the same company may be interested in designing competitive dashboard design for its newest models by better understanding customer preferences and needs. Each of these teams within the same company are often located in different locations and may not share raw data (e.g., share reports). As such, customer persona development within a relatively large enterprise can include redundant data collection steps.

By contrast to conventional customer persona development, embodiments of the present innovation relate to a user-experience development system. In one arrangement, the user-experience development system is configured to facilitate customer persona development and collaboration among company departments established in different geographical locations (e.g., different locations in the same state or different states in the same country, or even in different countries). Accordingly, the user-experience development system can reduce redundant persona development efforts within the company to improve efficiency and can provide an opportunity for cross-validation within an organization. As a result, the user-experience development system provides access to opportunities for innovation in service design to reach broader markets.

In one embodiment, the user-experience development system includes a persona development device which is configured to develop persona prototypes and to modify the persona prototypes into refined user personas such as via real-time analysis. In one embodiment, the persona development device is configured to receive real-time data from sensors and user interactions with the system. Further, the persona development device can be configured to provide design recommendations based on persona analysis and to track the performance of implemented design suggestions with real-time data.

Embodiments of the innovation relate to a persona development device comprising a controller having a memory and a processor. The controller is configured to receive a research request from a user interaction device, the research request including an attribute related to a persona. The controller is configured to, in response to identifying a correspondence between the attribute of the research request and a persona of a persona database, forward a request response including the persona to the user interaction device. The controller is configured to, in response to identifying a lack of correspondence between the attribute of the research request and a persona of a persona database, retrieve user data from a user data source, create a persona prototype based upon the user data and corresponding to the attribute of the research request, and forward a request response including the persona prototype to the user interaction device.

Embodiments of the innovation relate to, in a persona development device, a method of developing a persona. The method comprises receiving a research request from a user interaction device, the research request including an attribute related to a persona. The method comprises in response to identifying a correspondence between the attribute of the research request and a persona of a persona database, forwarding a request response including the persona to the user interaction device. The method comprises in response to identifying a lack of correspondence between the attribute of the research request and a persona of a persona database retrieving user data from a user data source, creating a persona prototype based upon the user data and corresponding to the attribute of the research request, and forwarding a request response including the persona prototype to the user interaction device.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a user-experience development system, according to one arrangement.

FIG. 2 illustrates a persona source device of the user-experience development system of FIG. 1, according to one arrangement.

FIG. 3 illustrates a persona template, such as utilized by the persona source device of FIG. 2, according to one arrangement.

FIG. 4 illustrates a persona development device of the user-experience development system of FIG. 1, according to one arrangement.

FIG. 5 illustrates a flowchart showing an example operation of the persona development device of FIG. 4, according to one arrangement.

FIG. 6 illustrates a persona development device of the user-experience development system, according to one arrangement.

FIG. 7 illustrates a persona development device of the user-experience development system, according to one arrangement.

FIG. 8 illustrates a persona development device of the user-experience development system, according to one arrangement.

### DETAILED DESCRIPTION

Embodiments of the present innovation relate to a user-experience development system. In one arrangement, the user-experience development system is configured to facilitate customer persona development and collaboration among company departments established in different geographical locations (e.g., different locations in the same state or different states in the same country, or even in different countries). Accordingly, the user-experience development system can reduce redundant persona development efforts within the company to improve efficiency and can provide an opportunity for cross-validation within the organization. As a result, the user-experience development system provides access to opportunities for innovation in service design to reach broader markets.

In one embodiment, the user-experience development system includes a persona development device which is configured to develop persona prototypes and to modify the persona prototypes into refined user personas such as via real-time analysis. In one embodiment, the persona development device is configured to receive real-time data from sensors and user interactions with the system. Further, the persona development device can be configured to provide design recommendations based on persona analysis and to track the performance of implemented design suggestions with real-time data.

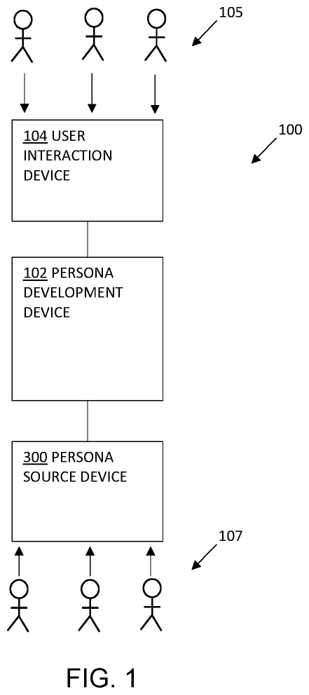

FIG. 1 illustrates a user-experience development system 100 which includes a persona development device 102 disposed in electrical communication with a user interaction device 104 and with a persona source device 300. The user-experience development system 100 allows different users 105, such as business stakeholders, product designers, marketers, and engineers to develop a shared understanding of the users of their products prior to engaging in the product development process. Further, the user-experience development system 100 allows the users 105 to validate product designs relative to these users during the product development process.

The user interaction device 104 is configured to exchange information with the persona development device 102 to allow the real-time development of a user persona. In one arrangement, the user interaction device 104 is configured as a central device that can facilitate learning from research conducted by various teams. The user interaction device 104 also facilitates the development process at different stages of a product or service design. By using personas at various stages of product or service development, organizations can ensure that their design decisions incorporate the needs of their customers in each design phase. Similarly, organizations can use personas to improve their marketing decisions, such as by helping marketing teams to decide which group of customers benefit most from an advertisement and how and where advertisements should be delivered to create the most impact.

In one arrangement, the user interaction device 104 can be configured as a central computer server device that facilitates communication and collaboration among users 105 or teams in a company that are in different geographical locations, such as in different locations in the same state or different states in the same country, or in different countries. The user interaction device 104 allows a number and variety of users 105 to contribute to the identification of attributes important for a target persona for a particular product or service. Each user 105 can communicate with the user interaction device 104 via an individual computerized device, such as a server, desktop, laptop, or tablet device via a network, such as a LAN or WAN. With such a configuration, the user interaction device 104 can improve efficiency (e.g., reduce redundant efforts) within an organization and can provide an opportunity for cross validation of product or service designs and real-time analysis. This, in turn, can provide the company with access to more opportunities for innovation in service design and with the ability to reach broader markets.

The persona source device 300 forms part of a shared system with a variety of users 107 and is configured to provide personas to the persona development device 102. Further, as will be described in detail below, the persona source device 300 is configured to automate the persona creation process which is effective in improving market needs when it is repeated periodically. This is because personas represent a snapshot of customers in a specific context at a specific period of time. To stay in touch with evolving customer needs, organizations can repeatedly engage in the persona development process. As such, the persona source device 300 provides an effective way to capture user needs and preferences efficiently, hence it can easily be used on a substantially continual basis.

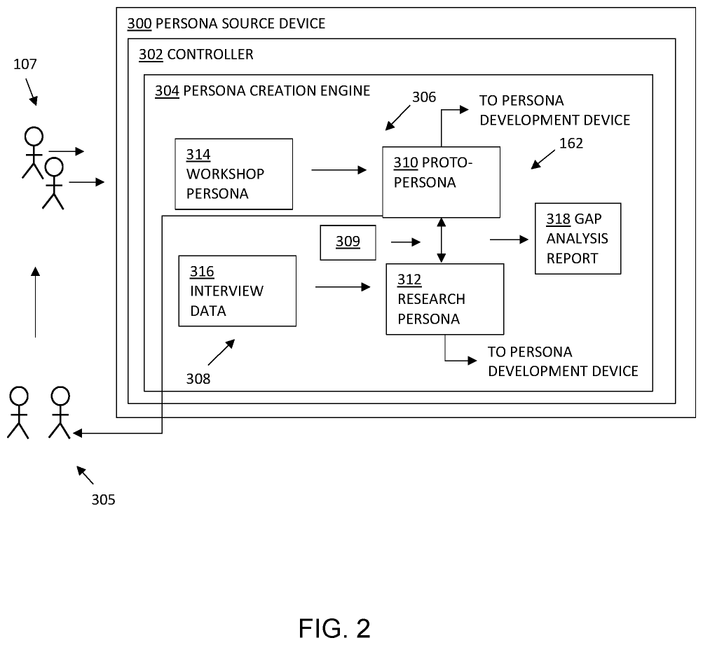

With reference to FIG. 2, in one arrangement, the persona source device 300, is a computerized device, such as a server, desktop, laptop, or tablet device having a controller 302, such as a processor and memory (e.g., a ROM or a RAM). During operation, the controller 302 is configured to execute a persona creation engine 304 to facilitate the creation of customer personas 162. Personas represent fictional, but realistic, representations of customer needs, challenges, preferences, and other characteristics which can help users 105, such as business leaders or stakeholders, build consensus about market needs.

With execution of the persona creation engine 304, the persona source device 300 can engage a proto-persona development process 306 and a research persona development process 308 to develop proto-personas 310 and research personas 312, respectively. Conventional proto-personas are assumption-based and are developed by members of an organization, usually through a workshop, where a group of selected employees are invited to estimate the goals, needs, behavior, and other life and work aspects of their customers. Conventional research personas are research-based and are developed by conducting customer research, such as through observational studies and/or conducting one-on-one interviews. The patterns identified by observing users and/or during the interviews help capture different aspects of life and work of customers that build the foundation for developing personas.

During the proto-persona development process 306, the persona creation engine 304 can receive one or more workshop personas 314 from participants 107. For example, prior to the workshop, key representatives of various departments that are the major stakeholders of the project are included as participants 107 and can provide information defining characteristics of the customers, such as via an online survey. The workshop holders 305 can analyze the survey responses to identify relevant spectrums or attributes to be used in the workshop. Additionally, the workshop holders 305 can use survey responses to create persona templates prior to the workshop.

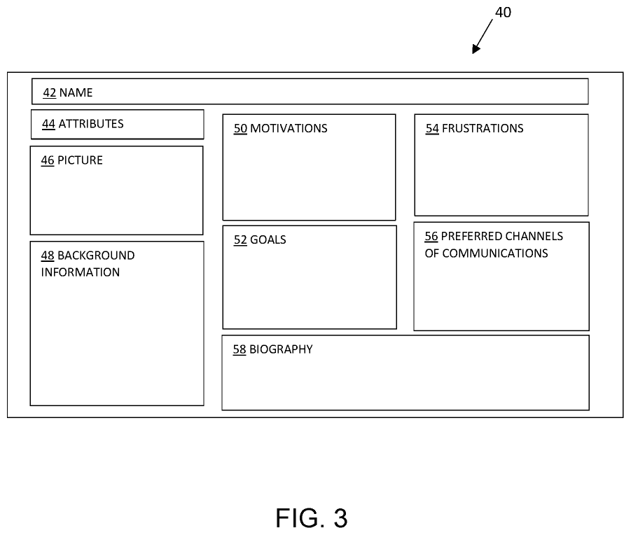

Persona templates typically include several sections summarizing a customer's background information (e.g., age, gender, occupation) as well as information about user needs, challenges, concerns, goals, and other characteristics that can impact product design decisions. Persona templates can have a variety of formats and elements. For example, FIG. 3 illustrates a persona template 40 which includes a customer name 42, attributes 44, picture 46, background information 48, motivations 50, goals 52, frustrations 54, preferred channels of communication 56, and biography information 58.

Returning to FIG. 2, during the workshop, the workshop holders 305 place the participants 107 into groups and encourage the participants 107 to utilize the persona templates 40 to create as many personas as they can. The participants 107 can provide the completed templates to the persona source device 300 as workshop personas 314. For example, the participants 107 can transmit the workshop personas 314 electronically to the persona source device 300. After receiving the workshop personas 314, the persona creation engine 304 can map the created workshop personas 314 along a variety of spectrums to identify patterns in the workshop personas 314. For example, assume the case where the pre-workshop analysis identified three distinct spectrums or attributes which were important to defining a set of customers, such as level of technology savvy, age, and education. The persona creation engine 304 can place each of the workshop personas 114 on each spectrum between a relatively low and a relatively high position, depending upon the information present in the workshop personas 314. For example, for a first workshop persona identifying a customer as having a high school education, the persona creation engine 304 can map that workshop persona to a lower portion of the education spectrum. However, for a second workshop persona identifying a customer as having a doctorate, the persona creation engine 304 can map that workshop persona to a higher portion of the education spectrum.

Based upon patterns identified on the spectrums, the persona creation engine 304 can merge the workshop personas 314 into a set of proto-personas 310. For example, assume that for the education spectrum, the majority of workshop personas 314 are clustered toward the higher portion of the spectrum. The persona creation engine 304 is configured to identify such clustering and to eliminate workshop personas 314 identifying customers as having an education on the lower end of the spectrum and to merge the remaining similar workshop personas 314 into one or more proto-personas. The persona creation engine 304 can also rank the resulting proto-personas 310 to prioritize implementation by the persona development device 102 and can forward the proto-personas 310 to the persona development device 102 for storage as a persona 162 in a persona database 112.

In one arrangement, the proto-persona development process can be repeated to update or refine the proto-personas as needed (e.g., through a subsequent proto-research persona development process). For example, assume the case where the participants 107 provide updated personas to the device 300 where the updated workshop personas 314 more specifically identify the education spectrum, as provided above, as a higher education spectrum. Based on this updated information, the persona creation engine 304 can identify clustering relative to the higher education spectrum. Further, the persona creation engine 304 can identify existing personas 162 stored by the persona development device 102 in the persona database 112 which include an education spectrum. The persona creation engine 304 can update the education spectrum aspect of those personas 162 with the information derived from the clustering identifies in the higher education spectrum.

Following generation of the proto-personas 310, the persona creation engine 304 can engage in a research persona development process 308. For example, the persona creation engine 304 can forward the proto-personas 310 to the workshop holders 305 for further review. The workshop holders 305 can utilize the information contained in the proto-personas 310 as criteria for recruiting new participants 107 and conducting one-on-one interviews.

Following the interviews, the workshop holders 305 can then provide the interview data 316 obtained from the individual interviews to the persona source device 300. The persona creation engine 304 can review the interview data 316 to identify behavior patterns, such as patters of the types of behaviors that leads a user to adopt a product or patterns of needs and goals that motivate a user pay for a service. For example, the persona creation engine 304 can map the interview data 316 along a variety of spectrums to identify patterns in the behavior of the participants 107. Based upon patterns identified on the spectrums, the persona creation engine 304 can merged the interview data 316 into a set of research personas 312. The persona creation engine 304 can also rank the research personas 312 to prioritize implementation by the persona development device 102 and can forward the research personas 312 to the persona development device 102 for storage in a persona database 112 as personas 162.

Following development of the research personas 312, the persona creation engine 304 is configured to provide a gap analysis of the proto-personas 310 and the research personas 312. For example, the persona creation engine 304 can execute a gap analysis function 309 to compare the information provided in the proto-personas 310 and research personas 312 and to identify any differences between the two. As a result of the comparison, the persona creation engine 304 can generate a gap analysis report 318 to identify an alignment and/or a lack of alignment between the two sets of personas 310, 312.

For example, assume the case where the proto-personas 310 identify a potential customer as having a high school level of education and the research personas 312 indicate a potential customer as having a college graduate school level of education. Comparison of the education level attribute of the proto-personas 310 and research personas 312 by the persona creation engine 304 using the gap analysis function 309 can identify this discrepancy. Accordingly, the resulting gap analysis report 318 can provide insight for improving the consensus among the users 107 and about the accuracy of the assumptions made about the market versus the market reality, thereby allowing the assumptions to be corrected and/or refined. The gap analysis report 318 can also provide insight for making the subsequent design and business decisions. Additionally, the gap analysis report 318 can be stored by the persona development device 102 as a key performance indicator (KPI) relative to a particular attribute of a persona.

Returning to FIG. 1, the persona development device 102 is configured to provide the user interaction device 104 with access to a variety of personas 162. Further the persona development device 102 can modify the personas 162 into refined persona prototypes 180 such as by using real-time data or develop persona prototypes based upon the users' needs. The persona development device 102 can also provide the users 105 with product or service design recommendations and can track the performance of implemented design suggestions.

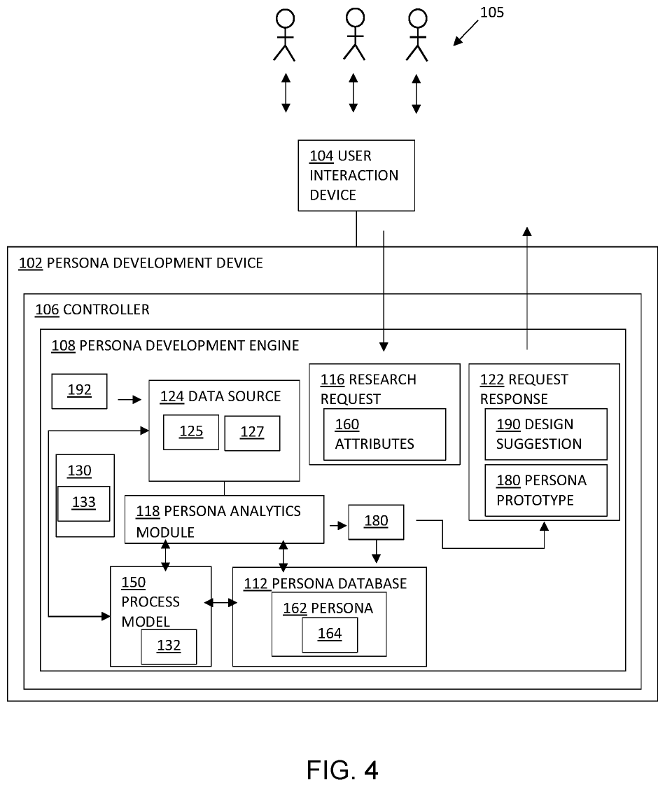

The persona development device 102, in one arrangement and with reference to FIG. 4, is a computerized device, such as a server, desktop, laptop, or tablet device having a controller 106, such as a processor and memory (e.g., a ROM or a RAM). During operation, the controller 106 is configured to execute a persona development engine 108 to facilitate customer persona development. With such a configuration, the persona development device 102 can modify a persona 162 or generate a refined persona prototype 180 to provide a better representation of the user represented by the persona.

In one arrangement, the persona development engine 108 can include a persona database 112 having a variety of personas, such as proto-personas 310, research personas 312 and/or persona prototypes created for any industry and for any purpose. For example, a persona database 112 developed for the automobile industry can include automobile customer personas while a persona database 112 developed for the exercise industry can include automobile customer personas.

As provided above, the persona source device 300 can provide proto-personas 310 and research personas 312 to the persona database 112. In another arrangement, a user 105 (e.g., decision maker, business owner, etc.) can upload personas to the persona database 112 where the personas have been developed using traditional methods (e.g., interviews with customers, etc.). Each persona 162 within the database 112 can include a variety of attributes 164 such as a research topic identifier, a scope identifier, and parameter data. Each persona 162 can also include development history associated with the persona, such as refinement process information and timeline information, as will be described below.

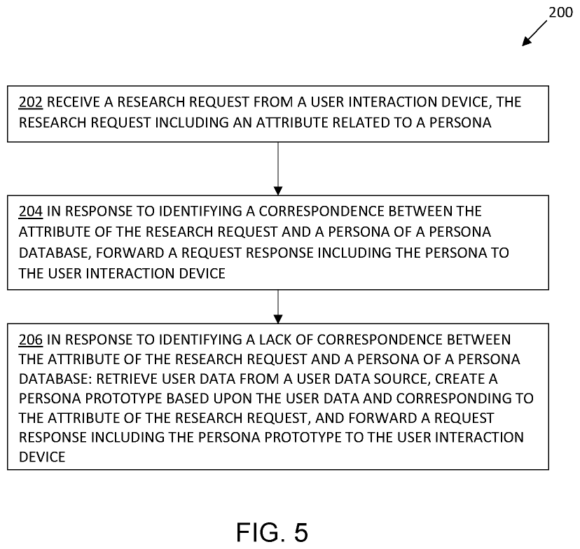

FIG. 5 illustrates a flow chart 100 of a procedure performed by the persona development device 102 of the user-experience development system 100 when providing personas to the user interaction device 104.

In element 202, the persona development device 102 is configured to receive a research request 116 from a user interaction device, the research request 116 including an attribute 160 related to a persona. In one arrangement, with reference to FIG. 4, a user or a group of users 105 can initiate operation of the persona development device 102 by entering a research request 116 into the user interaction device 104. As indicated above, the user interaction device 104 operates as a hub or group decision support system which facilitates the exchange of ideas among the various user for a given project. Accordingly, the use of the user interaction device 104 mitigates redundant activity among the distinct users 105 and provides the opportunity for input and cross-validation of the research request 116 before the transmitting the request 116 to the persona development device 102.

The research request 116 can include keywords or attributes 160 relating to a particular product and a persona 162 that the developers believe is associated with the product. For example, assume the case where the developers would like to improve a given smartwatch for either athletes or people who are serious about exercise. In such a case, the research request 116 can indicate that the product relates to a smartwatch and that the persona of interest includes the attributes of athletes or people who exercise regularly. The user interaction device 104 can, in turn, transmit the research request 116 to the persona development device 102.

In response to receiving the research request 116, a persona analytics module 118 of the persona development device 102 is configured extract keywords or attributes 160 from the research request 116 to identify the product or services associated with the request, as and to use the attributes 160 to retrieve a persona associated with, and in response to, the research request 116. For example, assume the case where the persona analytics module 118 has extracted the attributes 160 “smartwatch,” “athletes,” and “exercise” from the research request 116. Based the attributes 160, the persona analytics module 118 can perform a search of the persona database 112 to determine if corresponding attributes 164 exists as part of a persona 162 stored in the persona database 112.

Returning to FIG. 5, in element 204, in response to identifying a correspondence between the attribute 160 of the research request 116 and a persona 162 of a persona database 112, the persona development device 102 is configured to forward a request response 122 including the persona 162 to the user interaction device 104. For example, with reference to FIG. 4, assume the case where the persona analytics module 118 identifies a match between the attributes 160 (i.e., “smartwatch,” “athletes,” and “exercise”) identified in the research request 116 and the attributes 164 (i.e., “smartwatch,” “athletes,” and “exercise”) of one or more personas 162 in the persona database 112. Based upon this correspondence, the persona analytics module 118 can retrieve the matching personas 162 from the database and the persona development device 102 can forward a research response 122 to the user interaction device 104 which includes the identified persona from the database 112.

Returning to FIG. 5, in element 206 in response to identifying a lack of correspondence between the attribute 160 of the research request 116 and a persona 162 of the persona database 112, the persona development device 102 is configured to retrieve user data from a user data source 124, create a persona prototype 180 based upon the user data and corresponding to the attribute of the research request 116, and forward a request response 182 including the persona prototype 180 to the user interaction device 104.

With reference to FIG. 4, the data sources 124 can be configured in a variety of ways. For example, the data sources 124 can include aggregate data 125 from an aggregated data source, such as uploaded and/or updated by a customer of the user-experience development system 100 over time. In one arrangement, the aggregated data 125 can include information relating to customers, such as consumer data, market research data, and/or proto-persona workshop data, such as workshop personas 314 provided by the persona source device.

The data source 124 can also include real time data 127 received from a real-time data source which is configured to provide customer data to the persona development device 102 in substantially real-time. In one arrangement, the real-time data 127 can include data received from various sensors configured to collect attribute information from one or more customers or from other sources. For example, the source of the real-time data 127 can include data collected from smart phones or smart watches which can provide real-time information relating, for example, to customers' geographic locations, biological information (for example pulse rate, heart rate, etc.), social media use, shopping habits, etc. The source of the real-time data 127 can also include a user interaction source which collects data based upon customer interaction with a product and/or service, for example.

In the case where the persona analytics module 118 has not identified a match between an attribute 160 of a research request 116 and a persona 162 of the persona database 112, the persona analytics model 118 is configured to utilize user data 130 from the data source 124 and a process model 150 to create one or more persona prototypes 180 which include attributes 160, such as requested within the research request 116. For example, as indicated in FIG. 4, the persona analytics module 118 can access the data source 124 to retrieve user data 130 such as aggregated data 125 from the aggregated data source and/or real-time data 127 from the real-time data source as related to the attributes 160 included in the research request 116. The persona analytics module 118 is configured to then verify that attribute information 133 associated with the user data 130 corresponds with the attribute 160 of the research request 116. For example, in the case where the research request 116 identifies attributes 160 such as “smartwatch,” “athletes,” and “exercise”, the persona analytics module 118 can review the user data 130 from the data source 124 and can retrieve user data 130 which includes the attributes 133 of smartwatch,” “athletes,” and “exercise,” as identified in the request 116.

Following retrieval of the user data 130, the persona development engine 108 is configured to utilize the process model 150 to develop new persona prototypes 180. In one arrangement, the process model 150 is configured to map the user data 130 retrieved from the user data source 124 to a persona prototype template 132 to generate the persona prototype 180. For example, the process model 150 can identify and input consumer data, market research data, and/or proto-persona workshop data retrieved as user data 130 into a template 132, such as provided in FIG. 3. Once substantially populated with user data, the process model 150 can identify the template 132 as a persona prototype 180 and can output the persona prototype 180 to the persona analytics module 118 ad can update the persona database 112 to include the created persona prototype 180.

Following creation of the persona prototype 180, the personal analytics module 118 is configured to include this created persona prototype 180 in a request response 122 and to forward the request response 122 to the user interaction device 104.

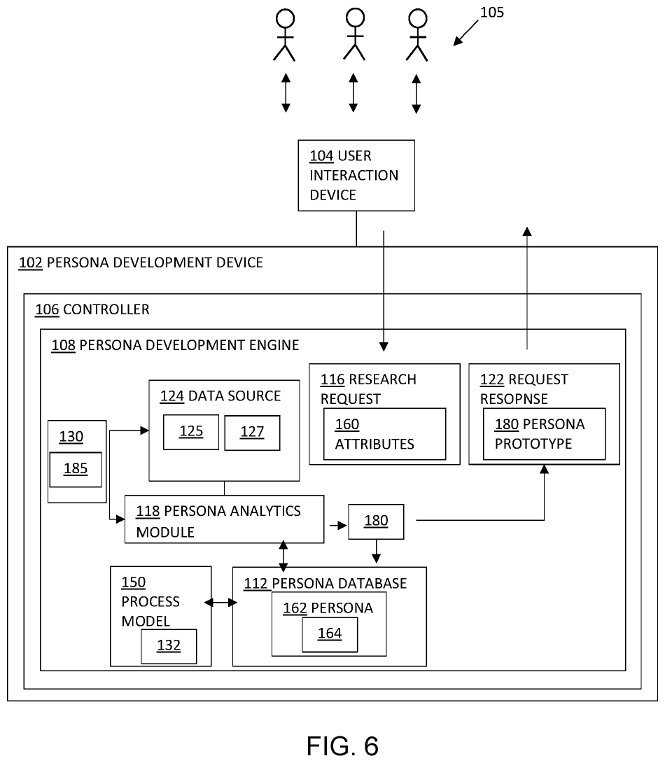

In the case where the persona analytics module 118 has not identified a match between an attribute 160 of a research request 116 and a persona 162 of the persona database 112, the persona development device 102 can also be configured to refine an existing persona 162 within the persona database 112 to create a persona prototype 180. During an example operation, as indicated in FIG. 6, as the persona analytics module 118 reviews the personas 162 in the persona database 112, the persona analytics module 118 can identify one or more personas 162 having one or more attributes 164 which correspond to the attributes 160 of the research request 116. In the case where the persona analytics module 118 detects a match between an attribute 164 of a persona 162 of the persona database 112 and a subset (e.g., at least one) of the attributes 160 of the research request 116, the persona analytics module 118 can retrieve user data 130 related to the matched attribute 164 of the persona 162 from the user data source 124 and can identify additional attributes 185 associated with the user data 130. The persona analytics module 118 is configured to then refine the attributes 164 of the persona 162 of the persona database 112 with the additional attributes 185 to generate the persona prototype 180.

For example, assume the case where the research request 116 is requesting personas having the attributes 160 of “smartwatch,” “athletes,” and “exercise.” Further assume that the persona analytics module 118 has identified a persona 162 in the persona database 112 having the attribute 164 of “athletes.” In such a case, during operation, the persona analytics module 118 can access the data source 124 to retrieve consumer or user data 130 from the aggregated data 125 and/or the real-time data 127 related to “athletes.” The persona analytics module 118 can review the user data 130 to identify attributes 185 related to the requested attribute 160. For example, based upon the review of the user data 130 from the user data source 124, assume the persona analytics module 118 identifies the consumer group “athletes” as using smartphones and as listening to music while they exercise. In such a case, the persona analytics module 118 can refine the persona 162 to include the attributes 185 of “smartphone” and “listen to music while exercising.”

Following creation of the persona prototype 180, the personal analytics module 118 can be configured to update the persona database 112 to include the refined persona 180 and to forward the persona prototype 180, as part of a request response 122, to the user interaction device 104.

In one arrangement, with reference to FIG. 4, the persona development device 102 is configured to forward one or more design suggestions 190 to the user interaction device 104 with the request response 122. For example, based upon the attributes 160 associated with the research request 116, the personal analytics module 118 is configured to review user data 130 from the user data source 124 and to apply a predictive model 192 to the user data 130 to create a design suggestion 190 related to the research request 116.

Assume the case where the research request 116 includes the attributes 160 of “athletes” and “exercise.” Based upon these attributes 160, during operation, the persona analytics module 118 can review the user data 130 from the user data source 124 (i.e., including aggregate data and/or real-time data) to identify consumer groups relating to “athletes,” and “exercise.” Following identification of the consumer groups, the persona analytics module 118 can apply the predictive model 192 to the consumer groups to extract additional consumer information or trends associated with the data 130. For example, assume that application of the predictive model 192 to the consumer group user data can identify the groups as trending toward using smartwatches versus smartphones over time. In such a case, the persona analytics module 118 can include a design suggestion 190 with the request response 122 the suggestion that there is a trend for consumers associated with “athletes” and “exercise” to use smartwatches in the future. The users 105 of the user interaction device 104 can choose to utilize this design suggestion when designing the service or product for their target consumer of interest.

As provided above, the persona development device 102 is configured to provide persona prototypes 180 and design suggestions 190 to the user interaction device 104 based upon aggregate data 125 and/or real-time data 127 analysis. In one arrangement, the persona development device 102 is configured to track the performance of product or service designs implemented by the users 105 of the user interaction device 104 and to provide feedback regarding the designs.

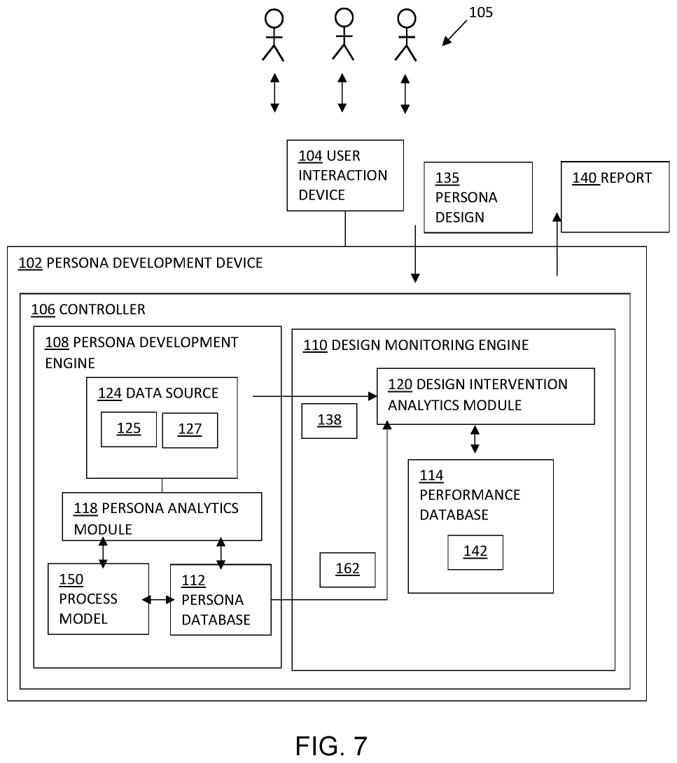

As provided above, the persona development device 102 can provide the user interaction device 104 with one or more persona prototypes 180, based upon a particular design specification, for use in developing a product or service. However, over time, the attributes of a persona 164 can change, thereby reducing the accuracy of the persona prototypes 180 included with the request response 122. Alternately, the users 105 of the user interaction device 104 may alter the persona prototype 180 used in the design of the product or service. To track and account for these types of changes, and indicated in FIG. 7, the persona development device 102 can include a design monitoring engine 110 configured to review and analyze persona design 135 utilized as part of a product or service development strategy.

For example, as will be described below, the design monitoring engine 110 can review the persona design 135 relative to updated personas 142 stored by the persona database 112 and based upon real-time data 138 received from the data source 124 and existing Key Performance Indicators (KPIs) from a performance library 114. As a result of the analysis, the design monitoring engine 110 is configured to provide feedback regarding a suggested persona design 135 for a particular product or service. For example, during operation the design monitoring engine 110 can approve the persona design 135, can suggest changes to the persona design 135, or can specify new KPIs for the performance library 114.

In one arrangement, the design monitoring engine 110 includes a performance library 114 which is configured to track relevant key performance indicators (KPIs) for all design interventions. For example, the performance library 114 can include KPIs such as web analytics (e.g., number of website visits, bounce rate, number of completed transactions) as well as other information, such as customer feedback. Further, the performance library 114 can include design intervention data, such as ratings for each feature that was initiated as a new intervention for the suggested product or maintenance service scheduling. In one arrangement, during operation, the performance library 114 can be updated on a substantially continuous basis by the persona development engine 108 based upon real-time data 127 received from the real-time data source and based upon changes to the personas 162 stored by the persona database 112.

The performance library 114 can also include updated personas 142 which include information derived from personas 162 received by a design intervention analytics module 120 from the persona database 112 and real-time data 127 received from the real-time data sources. As provided above, over time, the attributes 164 of a persona 162 can change. To mitigate the effects of the changes over time, in one arrangement, the design intervention analytics module 120 is configured to utilize the real-time data 138 to update various attributes 164 of the received personas 162, such as based upon the KPIs stored by the performance library, thereby generating updated personas 142. While the design intervention analytics module 120 can store the updated personas 142 as part of the performance library 114, the design intervention analytics module 120 is also configured to store the updated personas 142 within the persona database 112.

During operation, the design intervention analytic module 120 can receive a persona design 135 from an end user 105 via the user interaction device 104. For example, the persona design 135 can form part of a query to ascertain the performance of previous product or service designs or to initiate information gathering for a new design. The design intervention analytics module 120 is configured to review the persona design 135 and compare the persona design 135 with the updated personas 142 stored in the performance library 114.

Based upon the comparison, if the design intervention analytics module 120 identifies an existing updated persona 142 which corresponds to the persona design 135 provided by the user interaction device, the design intervention analytic module 120 can forward a design performance report 140 to the user interaction device 104 which approves the persona design 135. If the design intervention analytics module 120 does not identify an existing updated persona 142 which corresponds to the persona design 135, the design intervention analytic module 110 can review the performance library 114 to identify discrepancies or differences between the persona design 135 and the updated personas 142. In response to identifying these discrepancies (e.g., discrepancies among attributes) the design intervention analytics module 120 is configured to generate a report 140 which includes suggestions to refine the persona design 135.

Based upon the design reports 140, the users 105 can identify discrepancies between the expected results of the product or service design and the actual results and can change certain parameters of the process. For example, in the case where a discrepancy exists between the persona used during the product or service development and the attributes of the actual users of the product or service, the users 105 can update the attribute of the corresponding personas stored in the persona database 112 to match those of the actual users. In another example, in the case where the discrepancy exists, the users 105 can alter the product or service design and, as a result, can alter the attributes 160 of the persona requested in a subsequent research request 116.

As provided above, each of the persona development device 102, the user interaction device 104, and the persona source device 300 are configured to update the persona database 112 to update information or to add information for particular personas 162. For example, during operation the devices 104, 104, 300 can identify new or updated attributes 164 pertaining to one of more personas 162 and can alter the personas 162 stored within the persona database 112 to include these attributes 164.

In one arrangement, the persona development device 102 is configured to update the personas 162 of the persona database 112 in real-time based upon real-time data 138 received from the real-time data source 124. For example, over time consumers can change their behaviors or habits. In order to match the development of the consumers, the persona development device 102 can change or develop personas 162 over time as well.

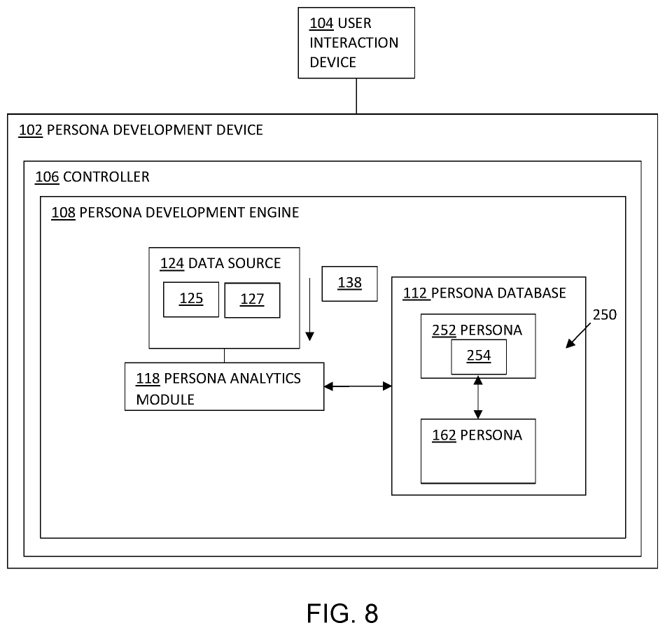

In use, and with reference to FIG. 8, the persona development engine 108 can receive, over time, real-time data 138 from data source 124 or from a real-time data source, such as via sensors or customer interaction with a product. For example, assume the case where a real-time data source, such as a smartwatch, of a person who exercises, provides real-time data 138 to the real-time data source which indicates the time the person exercises as well as the type of music the person listens to while exercising. In response to the real-time data 138 received from the data sources 124, in one arrangement, the persona development engine 108 can identify one or more personas 162 within the persona database 112 related to the real-time data 138 and can update one or more attributes 164 of the identified personas 162 to create an updated persona 252. For example, the persona analytics module 118 can review the persona database 112 for personas 162 which relate to a person who exercises and can include information related to the time that persona is likely to exercise as well as the type of music the persona is likely to listen to while exercising. With such a configuration, the persona development device 102 can generate and maintain up-to-date personas 162 within the database 112 in a substantially automated manner.

In one arrangement, when the persona analytics module 118 changes or refines attributes 164 of personas 162, the persona analytics module 118 can be configured to link updated personas to root personas to create persona journey maps 250. These persona journey maps 250 can provide a developmental history associated with the persona 162 over time. For example, during operation and as illustrated in FIG. 8, when the persona analytics module 118 updates a root persona 162 with a first set of real-time data 138, the persona analytics module 118 can create an updated persona 252 which is related to the root persona 164 via a tag or metadata 254 included in the updated persona 252. With subsequent updates of additional sets of real-time data 138, the persona analytics module 118 can create additional updated personas 252 having subsequent tags or metadata 254.

While various embodiments of the innovation have been particularly shown and described, it will be understood by those skilled in the art that various changes in form and details may be made therein without departing from the spirit and scope of the innovation as defined by the appended claims.

What is claimed is:

1. A persona development device, comprising:
a controller having a memory and a processor, the controller configured to:
receive a research request from a user interaction device, the research request including an attribute related to a persona;
in response to identifying a correspondence between the attribute of the research request and a persona of a persona database, forward a request response including the persona to the user interaction device; and
in response to identifying a lack of correspondence between the attribute of the research request and a persona of a persona database:
retrieve user data from a user data source,
create a persona prototype based upon the user data and corresponding to the attribute of the research request, and
forward a request response including the persona prototype to the user interaction device.

2. The persona development device of claim 1, wherein the controller is further configured to forward a design suggestion with the request response to the user interaction device, the design suggestion based upon the attribute of the research request.

3. The persona development device of claim 1, wherein:
when retrieving user data from the user data source, the controller is configured to verify attribute information associated with the user data corresponds with the attribute of the research request; and
when creating the persona prototype based upon the user data, the controller is configured to map the user data retrieved from the user data source to a persona prototype template to generate the persona prototype.

4. The persona development device of claim 3, wherein the controller is configured to store the persona prototype in the persona database.

5. The persona development device of claim 1, wherein:
when identifying a lack of correspondence between the attribute of the research request and the persona of the persona database, the controller is configured to detect a match between a subset of attributes of the research request and an attribute of a persona of the persona database;
when retrieving user data from a user data source, the controller is configured to retrieve user data related to the matched attribute of the persona from the user data source; and
when creating the persona prototype based upon the user data and corresponding to the attribute of the research request, the controller is configured to identify additional attributes associated with the user data and refine the persona of the persona database with the additional attributes to generate the persona prototype.

6. The persona development device of claim 5, wherein the controller is configured to store the persona prototype in the persona database.

7. The persona development device of claim 1, wherein the controller is further configured to:
receive a persona design from the user interaction device;
compare the persona design with updated personas of a performance library; and
in response to detecting a lack of correspondence between the persona design and the updated personas of a performance library, identify discrepancies between the persona design and the updated personas and generate a report which includes a persona design refinement suggestion.

8. The persona development device of claim 1, wherein the controller is configured to:
receive real-time data from the real-time data source;
in response to receiving the real-time data, identify one or more root personas of the persona database related to the real-time data;
update one or more attributes of the identified one or more personas to create an updated persona.

9. The persona development device of claim 8, wherein the controller is further configured link the updated persona to the root persona via a tag.

10. The persona development device of claim 1, wherein the controller is configured to receive the persona database from a persona development device, each persona within the persona database configured as at least one of a proto-persona developed by the persona development device and a research persona developed by the persona development device.

11. In a persona development device, a method of developing a persona, comprising:
receiving a research request from a user interaction device, the research request including an attribute related to a persona;
in response to identifying a correspondence between the attribute of the research request and a persona of a persona database, forwarding a request response including the persona to the user interaction device; and
in response to identifying a lack of correspondence between the attribute of the research request and a persona of a persona database:
retrieving user data from a user data source,
creating a persona prototype based upon the user data and corresponding to the attribute of the research request, and
forwarding a request response including the persona prototype to the user interaction device.

12. The method of claim 11, further comprising forwarding a design suggestion with the request response to the user interaction device, the design suggestion based upon the attribute of the research request.

13. The method of claim 11, wherein:
retrieving user data from the user data source comprises verifying attribute information associated with the user data corresponds with the attribute of the research request; and
creating the persona prototype based upon the user data comprises mapping the user data retrieved from the user data source to a persona prototype template to generate the persona prototype.

14. The method of claim 13, comprising storing the persona prototype in the persona database.

15. The method of claim 11, wherein:
identifying a lack of correspondence between the attribute of the research request and the persona of the persona database comprises detecting a match between a subset of attributes of the research request and an attribute of a persona of the persona database;
retrieving user data from a user data source comprises retrieving user data related to the matched attribute of the persona from the user data source; and
creating the persona prototype based upon the user data and corresponding to the attribute of the research request comprises identifying additional attributes associated with the user data and refine the persona of the persona database with the additional attributes to generate the persona prototype.

16. The method of claim 15, comprising storing the persona prototype in the persona database.

17. The method of claim 11, further comprising:
receiving a persona design from the user interaction device;
comparing the persona design with updated personas of a performance library; and
in response to detecting a lack of correspondence between the persona design and the updated personas of a performance library, identifying discrepancies between the persona design and the updated personas and generate a report which includes a persona design refinement suggestion.

18. The method of claim 11, comprising:
receiving real-time data from the real-time data source;
in response to receiving the real-time data, identifying one or more root personas of the persona database related to the real-time data; and
updating one or more attributes of the identified one or more personas to create an updated persona.

19. The method claim 18, further comprising linking the updated persona to the root persona via a tag.

20. The method of claim 11, comprising receiving the persona database from a persona development device, each persona within the persona database configured as at least one of a proto-persona developed by the persona development device and a research persona developed by the persona development device.
